(19) United States
(12) Patent Application Publication
(10) Pub. No.: US 2025/0190382 A1
(43) Pub. Date: Jun. 12, 2025

(54) NETWORK PACKET PROCESSING APPARATUS

(71) Applicant: Airoha Technology (Suzhou) Limited, Suzhou City (CN)

(72) Inventors: WEIHUA HUANG, Nanjing City (CN); Peng Du, Nanjing City (CN); Fei Yan, Nanjing City (CN)

(73) Assignee: Airoha Technology (Suzhou) Limited, Suzhou City (CN)

(21) Appl. No.: 18/963,735

(22) Filed: Nov. 28, 2024

(30) Foreign Application Priority Data
Dec. 8, 2023 (CN) 202311684458.9

(51) Int. Cl. G06F 13/28

(52) U.S. Cl. CPC G06F 13/28; G06F 2213/28

(57) ABSTRACT

A network packet processing apparatus includes a packet buffer, a ring buffer and a network processing unit (NPU). The packet buffer is used for storing a network packet. The ring buffer is used for storing a packet descriptor of the network buffer, where the packet descriptor includes a first field, and the first field is used for indirectly indicating a buffer address in the packet buffer at which the network packet is stored. The NPU is used for reading the packet descriptor from the ring buffer, and performing predetermined packet processing of the network packet according to the packet descriptor.

### BACKGROUND OF THE INVENTION

### 1. Field of the Invention

The present invention relates to network packet processing, and more particularly, to a network packet processing apparatus that uses indirect addressing in a packet descriptor to indicate a buffer address and/or uses a direct memory access (DMA) controller to request an available buffer address in a packet buffer and write address-related information into the packet descriptor.

### 2. Description of the Prior Art

A network processing unit (NPU) is a high-speed programmable processor specially used for network packet processing such as network packet forwarding, and has some features and architecture to accelerate processing efficiency of network packets. Generally speaking, when a conventional network processor forwards a network packet, it needs to read a packet descriptor of the network packet from a ring buffer to acquire a buffer address of the network packet stored in a packet buffer and a packet length of the network packet. Assume that the ring buffer is implemented using a static random access memory (SRAM), and one read operation of the SPAM takes 14 memory cycles. Since reading of the packet descriptor requires two read operations of the SPAM, it takes 28 clock cycles.

In addition, the conventional network processor is also responsible for requesting available buffer addresses in the packet buffer from a management circuit of the packet buffer, and using the buffer addresses to update packet descriptors stored in the ring buffer, where the packet descriptors are used by the DMA controller to write subsequent received network packets into the packet buffer. The conventional network processor uses the management circuit of the packet buffer to request an available buffer address in the packet buffer, which consumes at least 20 memory cycles. In addition, one write operation of the SRAM takes 7 memory clocks. Since updating of the packet descriptor stored in the ring buffer requires two write operations of the SPAM, it takes 14 memory cycles. As a result, a total of at least 34 memory cycles are consumed.

The conventional network processor's management of the ring buffer consumes a lot of time, thus affecting the processing efficiency of the overall packet forwarding. Thus, there is a need for optimizing the management of the ring buffer to reduce the network processor's time spent on managing the ring buffer, which can improve the overall processing efficiency of packet forwarding.

### SUMMARY OF THE INVENTION

One of the objectives of the claimed invention is to provide a network packet processing apparatus that uses indirect addressing in a packet descriptor to indicate a buffer address and/or uses a DMA controller to request an available buffer address in a packet buffer and write address-related information into the packet descriptor.

According to a first aspect of the present invention, an exemplary network packet processing apparatus is disclosed. The exemplary network packet processing apparatus includes a packet buffer, a ring buffer, and a network processing unit (NPU). The packet buffer is arranged to store a network packet. The ring buffer is arranged to store a packet descriptor of the network packet, wherein the packet descriptor comprises a first field, the first field is arranged to indirectly indicate a buffer address of the network packet in the packet buffer, and the packet descriptor does not directly record the buffer address. The NPU is arranged to read the packet descriptor from the ring buffer, and perform predetermined packet processing of the network packet according to the packet descriptor.

According to a second aspect of the present invention, an exemplary network packet processing apparatus is disclosed. The exemplary network packet processing apparatus includes a packet buffer, a ring buffer, and a direct memory access (DMA) controller. The packet buffer is arranged to store a network packet. The ring buffer is arranged to store a packet descriptor of the network packet, wherein the packet descriptor comprises a first field. The DMA controller includes a control circuit. The control circuit is arranged to write the network packet into the packet buffer, and store address-related information of a buffer address of the network packet in the packet buffer into the first field.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network packet processing apparatus according to an embodiment of the present invention.

FIG. 2 is a diagram illustrating the mapping relationship between the address identification code and the buffer address according to an embodiment of the present invention.

FIG. 3 is a flowchart of network packet transmission performed through the DMA controller according to an embodiment of the present invention.

FIG. 4 is a flowchart of network packet forwarding performed through the NPU according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

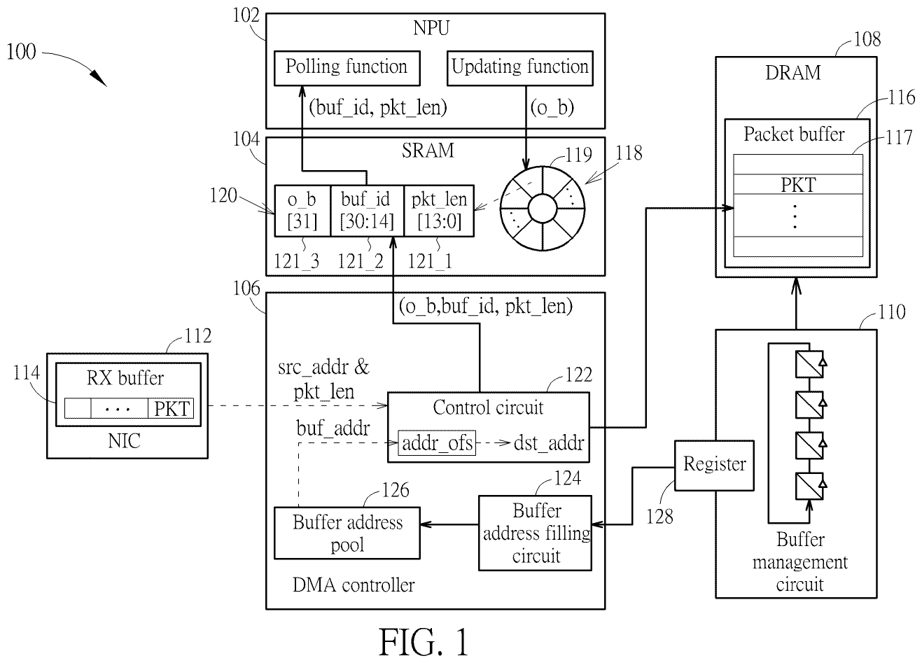

FIG. 1 is a diagram illustrating a network packet processing apparatus according to an embodiment of the present invention. For example, the network packet processing apparatus 100 may be employed by a network device such as a gateway. As shown in FIG. 1, the network packet processing apparatus 100 may include a network processing unit (NPU) 102, a static random access memory (SRAM) 104, a direct memory access (DMA) controller 106, a dynamic random access memory (DRAM) 108, a buffer management circuit 110 and a network interface card (NIC) 112. It should be noted that only the components pertinent to the present invention are illustrated in FIG. 1. In practice, the network packet processing apparatus 100 may include additional components to achieve designated functions.

The NIC 112 may be implemented using a network chip, and may include a receive (RX) buffer 112. For example, the RX buffer 112 may be implemented using a first-in first-out (FIFO) buffer. When the NIC 112 receives network packets PKT from a network port, the network packets PKT are first buffered in the internal buffer (i.e., RX buffer 112) of the NIC 112, and then the DMA controller 106 copies and writes each of the network packets PKT buffered in the RX buffer 112 into the packet buffer 116 that is allocated in the DRAM 108. When the packet buffer 116 is being initialized, the packet buffer 116 is divided into a plurality of storage blocks 117 according to a fixed block size (e.g., 2K bytes or 4K bytes), where the storage blocks 117 are used to store a plurality of network packets PKT, respectively. Hence, the network packets PKT buffered in the RX buffer 112 can be written into available storage blocks 117 in the packet buffer 116 through the DMA controller 106.

In addition, the SRAM 104 has a ring buffer 118 that is allocated for reception of network packets. The ring buffer 118 is divided into a plurality of storage blocks 119 for storing a plurality of packet descriptors 120 of a plurality of network packets, respectively. Each packet descriptor 120 records some metadata of a corresponding network packet. In this embodiment, the packet descriptor 120 includes a plurality of fields 121_1, 121_2, 121_3, where the field 121_1 (length=14 bits) is used to record the packet length pkt_len, the field 121_2 (length=17 bits) is used to record address-related information, and the field 121_3 (length=1 bit) is used to record a control code o_b. Compared with the conventional packet descriptor that uses a 32-bit field to directly record the buffer address of the network packet PKT stored in the packet buffer 116, the packet descriptor 120 of the present invention records an address identification code buf_id through the 17-bit field 121_2, where the address identification code buf_id is used to indirectly indicate the buffer address of the network packet PKT stored in the packet buffer 116.

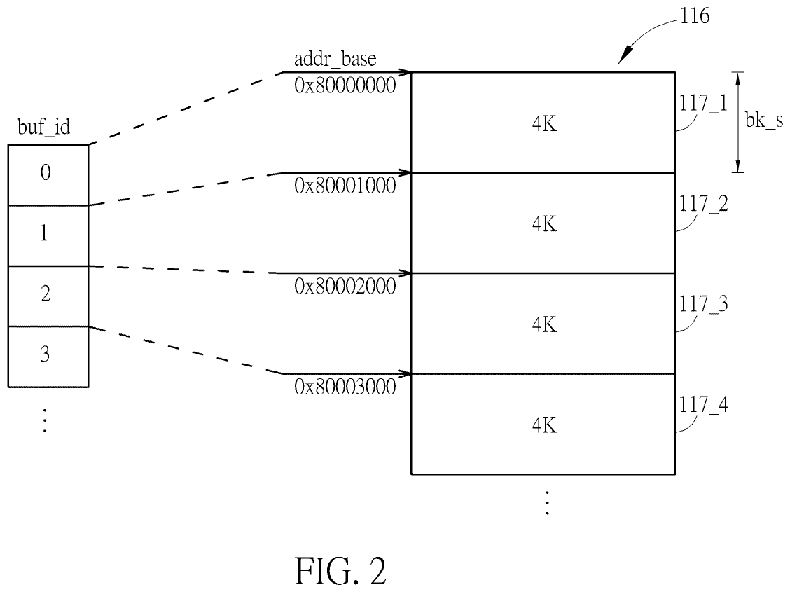

FIG. 2 is a diagram illustrating the mapping relationship between the address identification code buf_id and the buffer address buf_addr according to an embodiment of the present invention. The packet buffer 116 is divided into a plurality of storage blocks (e.g., storage blocks 117_1, 117_2, 117_3, 117_4), the block size bk_s of each storage block is 4K bytes, and the base address addr_base of the packet buffer 116 is 0x80000000. A plurality of storage blocks are mapped to a plurality of address identification codes buf_id, respectively. For example, the mapping relationship between the buffer address (i.e., the start address) buf_addr of each storage block and the address identification code buf_id can be expressed as buf_addr=addr_base+buf_id*bk_s. However, this is for illustrative purposes only, and is not meant to be a limitation of the present invention. In practice, any means capable of using fewer bits to implement indirect addressing of the buffer address of the network packet stored in the packet buffer can be adopted. These alternative designs all fall within the scope of the present invention.

To put it simply, the packet descriptor 120 of the present invention does not directly record the buffer address of the network packet PKT stored in the packet buffer 116. Since the number of bits (17 bits) required for indirect addressing (i.e., address identification code buf_id) is much smaller than the number of bits (32 bits) required for direct addressing (i.e., buffer address), the NPU 102 only needs one read operation of the SRAM 104 for retrieving the packet descriptor 120. Supposing that one read operation of SRAM 104 takes 14 memory cycles, the reading of the packet descriptor 120 only takes 14 memory cycles. Therefore, the time required by the NPU 102 to read the packet descriptor 104 can be greatly reduced, thereby improving the processing efficiency of the overall packet forwarding.

In addition, compared to the conventional network processor that is also responsible for ring buffer's management tasks including requesting for buffer addresses that are available in the packet buffer and updating the packet descriptors stored in the ring buffer by the buffer addresses, the network packet processing apparatus 100 of the present invention offloads these management tasks of the ring buffer to the DMA controller 106. In this way, the NPU 102 spends less time on managing the ring buffer, which further improves the processing efficiency of the overall packet forwarding. As shown in FIG. 1, the DMA controller 106 includes a control circuit 122, a buffer address filling circuit 124 and a buffer address pool 126. In addition to the network packet transmission between the RX buffer 114 and the packet buffer 116, the control circuit 122 further stores the field data into the packet descriptors 120. In addition, the buffer address filling circuit 124 is responsible for storing available buffer addresses in the packet buffer 116 into the buffer address pool 126.

Please refer to FIG. 3 in conjunction with FIG. 1. FIG. 3 is a flowchart of network packet transmission performed through the DMA controller 106 according to an embodiment of the present invention. Provided that the result is substantially the same, the steps are not required to be executed in the exact order shown in FIG. 3. At step S302, after receiving the network packet PKT, the NIC 112 buffers the network packet PKT in the RX buffer (e.g., FIFO buffer) 114. At step S304, the DMA controller 106 initializes the transmission of the network packet PKT stored in the RX buffer 114. For example, the control circuit 122 sets the storage address of the network packet PKT in the RX buffer 114 as the source address src_addr, and sets the data length of the transmission according to the packet length pkt_len of the network packet PKT. In addition, the control circuit 122 obtains the buffer address buf_addr available in the packet buffer 116 from the buffer address pool 126, and sets the destination address dst_addr according to the obtained buffer address buf_addr. In this embodiment, the control circuit 122 may add an address offset addr_ofs to the buffer address buf_addr for setting the destination address dst_addr (i.e., dst_addr=buf_addr+addr_ofs), where the address offset addr_ofs is mainly used to reserve some space for header expansion. At step S306, the control circuit 122 copies the network packet PKT from the RX buffer 114 of the NIC 112 and writes it into the storage block 117 in the packet buffer 116 according to the transmission parameters (src_addr, dst_addr, pkt_len).

After completing the transmission of the network packet PKT, the control circuit 122 updates the corresponding field data of the packet descriptor 120 in the ring buffer 118 that is allocated to the network packet PKT (step S308). In this embodiment, the control circuit 122 converts the buffer address dst_addr (length=32 bits) of the network packet PKT stored in the packet buffer 116 into the address identification code buf_id (length=17 bits). For example, the address offset addr_ofs is first subtracted from the buffer address dst_addr to restore the buffer address buf_addr (which corresponds to the start address of the storage block 117), and then the identification code buf_id is determined according to the mapping relationship shown in FIG. 2. However, this is for illustrative purposes only, and is not meant to be a limitation of the present invention. Any means capable of using fewer bits to indirectly address the buffer address of the network packet in the packet buffer can be adopted. The control circuit 122 sets the control code o_b by 1 (i.e., o_b=1), and writes it into the field 121_3 of the packet descriptor 120 to instruct that processing of the packet descriptor 120 is handed over to the NPU 102. In addition, the control circuit 122 writes the address identification code buf_id into the field 121_2 of the packet descriptor 120, and writes the packet length pkt_len into the field 121_1 of the packet descriptor 120.

As mentioned above, the control circuit 122 obtains the buffer address buf_addr available in the packet buffer 116 from the buffer address pool 126. In this embodiment, the buffer address pool 126 is used to store a plurality of buffer addresses buf_addr available in the packet buffer 116. For example, the capacity of the buffer address pool 126 is equal to M. Therefore, the buffer address pool 126 can store at most M available buffer addresses in the packet buffer 116. In addition, the buffer address filling circuit 124 is responsible for requesting the buffer addresses and maintaining the buffer address pool 126. As shown in FIG. 1, the buffer management circuit 110 is hardware that is responsible for managing usage of the packet buffer 116. That is, the buffer management circuit 110 can deal with initialization of the packet buffer 116, allocation of storage blocks, recycling of storage blocks, etc., without intervention of the processor (software). Hence, the buffer address filling circuit 124 can request a plurality of available buffer addresses from the buffer management circuit 110 through the register 128 of the buffer management circuit 110. For example, when the buffer address pool 126 is being initialized, the buffer address filling circuit 124 is used to request M available buffer addresses from the buffer management circuit 110 and store the M available buffer addresses into the buffer address pool 126. In addition, whenever the control circuit 122 reads a buffer address buf_addr from the buffer address pool 126, the buffer address buf_addr will be marked as “used” in the buffer address pool 126. Therefore, after the control circuit 122 transfers N network packets PKT in the RX buffer 114 to the packet buffer 116, the buffer addresses in the buffer address pool 126 that are available to the control circuit 122 will be reduced from the original M buffer addresses to (M-N) buffer addresses. In this embodiment, the buffer address filling circuit 124 is further used to monitor the usage of the buffer address pool 126. When the number of available buffer addresses in the buffer address pool 126 that are not used by the control circuit 122 yet reaches A (e.g.,

$$A = \frac{M}{2} ) ,$$

the buffer address filling circuit 124 requests (M-A) available buffer addresses from the buffer management circuit 110 through the register 128, and stores the (M-A) available buffer addresses into the buffer address pool 126.

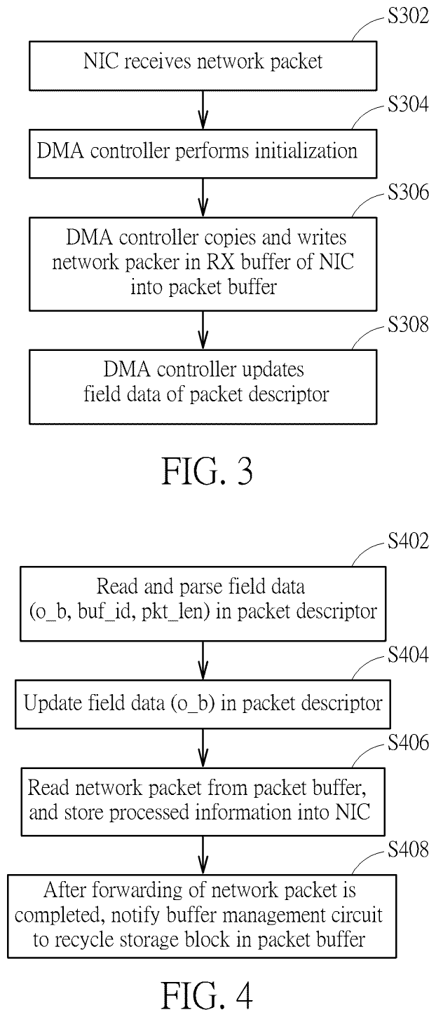

The NPU 102 can read the packet descriptor 120 from the ring buffer 118, and perform predetermined packet processing of the network packet PKT according to the packet descriptor 120. For example, the NPU 102 can assist the forwarding of the network packet PKT. Please refer to FIG. 4 in conjunction with FIG. 1. FIG. 4 is a flowchart of network packet forwarding performed through the NPU 102 according to an embodiment of the present invention. Provided that the result is substantially the same, the steps are not required to be executed in the exact order shown in FIG. 4. At step S402, the NPU 102 reads and parses the field data in the packet descriptor 120. For example, the NPU 102 first reads the field 121_3 to obtain the control code o_b. When the value of the control code o_b is 1 (i.e., o_b=1), implying that processing of the packet descriptor 120 has been handed over from the DMA controller 106 to the NPU 102, the NPU 102 further reads the field 121_2 and the field 121_1 to obtain the address identification code buf_id and the packet length pkt_len, respectively, and converts the address identification code buf_id into the buffer address of the network packet PKT in the packet buffer 116. After the NPU 102 reads and parses the field data in the packet descriptor 120, the NPU 102 updates the field data in this packet descriptor 120. In this embodiment, the NPU 102 only needs to update the control code o_b of the field 121_1 by setting the control code o_b to 0 (i.e., o_b=0) to indicate that processing of the packet descriptor 120 is handed over to the DMA controller 106. Afterwards, the DMA controller 106 can reuse the packet descriptor 120 to record field data (e.g., buf_id and pkt_len) of other network packet. At step S406, the NPU 102 reads the packet content of the network packet PKT to be forwarded from the packet buffer 116, and performs predetermined processing to write the processed information (e.g., address and length) into a packet descriptor included in a transmit (TX) ring buffer (now shown) of the NIC 112. After the forwarding of the network packet PKT is completed, the NPU 102 notifies the buffer management circuit 110 through the register 128, such that the buffer management circuit 110 notified by the NPU 102 can recycle the storage block 117 in the packet buffer 116 that is originally used to store the network packet PKT (step S408).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network packet processing apparatus comprising:
a packet buffer, arranged to store a network packet;
a ring buffer, arranged to store a packet descriptor of the network packet, wherein the packet descriptor comprises a first field, the first field is arranged to indirectly indicate a buffer address of the network packet in the packet buffer, and the packet descriptor does not directly record the buffer address; and
a network processing unit (NPU), arranged to read the packet descriptor from the ring buffer, and perform predetermined packet processing of the network packet according to the packet descriptor.

2. The network packet processing apparatus of claim 1, further comprising:
a direct memory access (DMA) controller, comprising:
a control circuit, arranged to write the network packet into the packet buffer, convert the buffer address of the network packet in the packet buffer into an address identification code, and store the address identification code into the first field.

3. The network packet processing apparatus of claim 2, wherein the packet buffer comprises a plurality of storage blocks used for storing a plurality of network packets, respectively; and the control circuit is arranged to map the plurality of storage blocks to a plurality of address identification codes, respectively.

4. The network packet processing apparatus of claim 2, wherein the packet descriptor further comprises a second field; when the address identification code is stored into the first field, the DMA controller is further arranged to store a control code into the second field to indicate that processing of the packet descriptor is handed over to the NPU.

5. The network packet processing apparatus of claim 2, wherein the packet descriptor further comprises a second field; after reading the packet descriptor from the ring buffer, the NPU is further arranged to store a control code into the second field to indicate that processing of the packet descriptor is handed over to the DMA controller.

6. The network packet processing apparatus of claim 2, wherein the DMA controller further comprises:
a buffer address pool, arranged to store a plurality of available buffer addresses in the packet buffer;
the control circuit is further arranged to read an available buffer address from the buffer address pool, and determine the buffer address of the network packet in the packet buffer according to the available buffer address.

7. The network packet processing apparatus of claim 6, further comprising:
a buffer management circuit, arranged to manage usage of the packet buffer;
wherein the DMA controller further comprises:
a buffer address filling circuit, wherein the plurality of available buffer addresses are obtained through the buffer address filling circuit that requests the plurality of available buffer addresses from the buffer management circuit.

8. The network packet processing apparatus of claim 7, wherein a capacity of the buffer address pool is equal to M, and when the buffer address pool is being initialized, the buffer address filling circuit is arranged to request M available buffer addresses from the buffer management circuit, and store the M available buffer addresses into the buffer address pool.

9. The network packet processing apparatus of claim 7, wherein a capacity of the buffer address pool is equal to M, and the buffer address filling circuit is arranged to monitor usage of the buffer address pool; when a number of available buffer addresses in the buffer address pool that are not used by the control circuit yet reaches A, the buffer address filling circuit is arranged to request (M-A) available buffer addresses from the buffer management circuit, and store the (M-A) available buffer addresses into the buffer address pool.

10. A network packet processing apparatus comprising:
a packet buffer, arranged to store a network packet;
a ring buffer, arranged to store a packet descriptor of the network packet, wherein the packet descriptor comprises a first field; and
a direct memory access (DMA) controller, comprising:
a control circuit, arranged to write the network packet into the packet buffer, and store address-related information of a buffer address of the network packet in the packet buffer into the first field.

11. The network packet processing apparatus of claim 10, further comprising:
a network processing unit (NPU), arranged to perform predetermined packet processing of the network packet according to the packet descriptor;
wherein the packet descriptor further comprises a second field; when the address-related information is stored into the first field, the DMA controller is further arranged to store a control code into the second field to indicate that processing of the packet descriptor is handed over to the NPU.

12. The network packet processing apparatus of claim 10, further comprising:
a buffer address pool, arranged to store a plurality of available buffer addresses in the packet buffer;
the control circuit is further arranged to read an available buffer address from the buffer address pool, and determine the buffer address of the network packet in the packet buffer according to the available buffer address.

13. The network packet processing apparatus of claim 10, further comprising:
a buffer management circuit, arranged to manage usage of the packet buffer;
wherein the DMA controller further comprises:
a buffer address filling circuit, wherein the plurality of available buffer addresses are obtained through the buffer address filling circuit that requests the plurality of available buffer addresses from the buffer management circuit.

14. The network packet processing apparatus of claim 13, wherein a capacity of the buffer address pool is equal to M, and when the buffer address pool is being initialized, the buffer address filling circuit is arranged to request M available buffer addresses from the buffer management circuit, and store the M available buffer addresses into the buffer address pool.

15. The network packet processing apparatus of claim 13, wherein a capacity of the buffer address pool is equal to M, and the buffer address filling circuit is arranged to monitor usage of the buffer address pool; when a number of available buffer addresses in the buffer address pool that are not used by the control circuit yet reaches A, the buffer address filling circuit is further arranged to request (M-A) available buffer addresses from the buffer management circuit, and store the (M-A) available buffer addresses into the buffer address pool.
